(19) United States
(12) Patent Application Publication
(10) Pub. No.: US 2025/0227202 A1
(43) Pub. Date: Jul. 10, 2025

(54) CONTINUOUS MOBILE WIRELESS LIVE BROADCASTING AND REAL-TIME VIDEO CONFERENCING DEVICE

(71) Applicant: Kwang Hyun YOON, Goyang-si (KR)

(72) Inventor: Kwang Hyun YOON, Goyang-si (KR)

(21) Appl. No.: 18/847,057

(22) PCT Filed: Mar. 15, 2023
(86) PCT No.: PCT/KR2023/003491

§ 371 Date: Sep. 13, 2024

(30) Foreign Application Priority Data
Mar. 15, 2022 (KR) 10-2022-0031761
Mar. 24, 2022 (KR) 10-2022-0036808

(51) Int. Cl. H04N 7/15; H04B 7/185; H04N 23/661; H04N 23/90

(52) U.S. Cl. CPC H04N 7/152; H04B 7/18504; H04N 23/661; H04N 23/90

(57) ABSTRACT

The present invention relates to a mobile live broadcasting and conference device and, more specifically, to “Cartlive” that is a mobile live broadcasting device which conducts real-time relaying and conferences with a plurality of terminals including a host terminal and a guest terminal by using a relay terminal capable of real-time relaying.

### TECHNICAL FIELD

The present invention relates to a mobile live broadcasting and conference device, and more specifically, to “Cartlive” that is a mobile live broadcasting device which conducts a real-time relay and a conference with a plurality of terminals including a host terminal and a guest terminal by using a relay terminal that enables the real-time relay.

### BACKGROUND ART

When a video conference is conducted or a site is introduced by using a real-time relay system, it is possible to provide an image along with an explanation while capturing an image of the site by directly moving the real-time relay system. It can be said that video conference is common to conduct conferences while mutually transmitting and receiving data in a fixed conference room, but when interviews or real-time broadcasts are conducted in places such as outside and a site, a relay device is necessarily equipped in a mobile type.

However, when a user wants to see or know a product or current state in detail in real time during real-time broadcasting, the user needs to deliver what he/she wants to know through a voice, and the user who performs mobile broadcasting needs to move and explain while capturing the image. When such a case occurs during real-time broadcasting, there is a problem in that mutual communication may not be complete, and accordingly, it takes a lot of time, and it is difficult to expect satisfactory results for mutual conferences. In addition, the existing mobile relay method proceeds in the order of “movement->installation->relay and conference->withdrawal”, which is called a mobile type relay method, but in the end, it is necessary to transmit the image by fixing the relay device to a predetermined place.

### DISCLOSURE

### Technical Problem

Therefore, an object of the present invention is to provide a mobile live broadcasting device which may continuously move a relay system that has to be fixed after installation over a wide area and provide relay and conference services by simplifying the relay method from an existing four-step method “1. movement->2. installation->3. relay and conference->4. withdrawal->1. movement” to a three-step method “1. movement->2. installation->3. relay and conference->1. movement”.

### Technical Solution

To achieve the above object, according to the present invention, a mobile live broadcasting device which conducts a real-time relay with a plurality of terminals including a host terminal and a guest terminal by using a relay terminal that enables the real-time relay, includes: a mobile cart including a cart body having shelves formed thereon and wheel units supported by the cart body for moving; a communication unit supported by the mobile cart and configured to transmit and receive data to and from the relay terminal; a camera unit including at least one fixed camera supported by the mobile cart to capture an image and at least one mobile camera separated from the mobile cart, having a mobile communication unit, and configured to capture an image; a display unit configured to display an image including an image captured by the camera unit; a user input unit configured to input a user's command; and a control unit configured to control the communication unit to transmit the image captured by the camera unit to the relay terminal such that the image is displayed on the host terminal and the guest terminal, to control the display unit to display an image of the host terminal received from the relay terminal, an image of the guest terminal, and the image captured by the camera unit, and to control, when area data of any one area from among image areas captured by the camera unit is input from the host terminal, the guest terminal, and the user input unit, the at least one mobile camera such that the at least one mobile camera moves to an area corresponding to the input area data to capture the image. The mobile live broadcasting device according to the present invention provides an image by conducting a real-time relay to the host terminal and the guest terminal by using the relay terminal while moving using the mobile cart, and when the area data is input from a relay image among real-time images, the mobile cameras capture the image while moving to the input area data, so that it is possible to rapidly provide a clear image, thereby improving a speed of data provision and clarity of the provided data.

In this case, the at least one mobile camera may include a plurality of mobile cameras, and the control unit may control the plurality of mobile cameras to move to the area corresponding to the input area data and macro-capture an image of an area corresponding to the area data that is input in at least two directions so as to transmit the image to the relay terminal, so that it is preferable to provide an image for the input area data captured in a plurality of directions, thereby satisfying a user, a host, and a guest who receive the image.

In addition, the control unit may control the plurality of mobile cameras to move such that when a repetitive movement operation is recognized in the macro-captured image, a pattern of the repetitive movement operation may be simultaneously captured, so that when production and work operations are performed in the input area, it is preferable to check the entire operation on one screen.

In this case, the plurality of mobile cameras may include a telephoto camera with a telephoto lens capturing a long distance area and a wide-angle camera with a wide-angle lens capturing a wide area, so that it is preferable to capture an area input using the wide-angle camera that is moved while directly capturing the input area data using the telephoto camera.

In addition, each of the plurality of mobile cameras may further include at least one microphone configured to receive a voice including a user's voice, so that it is preferable to provide a voice of the input area.

### Advantageous Effects

According to the present invention, the mobile live broadcasting device provides an image by conducting real-time relay with the host terminal and the guest terminal by using a plurality of cameras and a relay terminal while being moved using the mobile cart. Therefore, according to the present invention, the mobile live broadcasting device may be continuously moved using characteristics of a three-step method “1. movement->2. installation->3. relay and conference->4. withdrawal->1. movement” instead of a four-step method “1. movement->2. installation->3. relay and conference->1. movement” so that it is possible to conduct a relay and a real-time conference while being continuously moved by using a single relay mobile cart system without installing a relay system for each place, and thus it is possible to rapidly provide a clear image without limitation of a place, thereby improving a speed of data provision and clarity of the provided data.

### DESCRIPTION OF DRAWINGS

FIG. 1 is an exemplary diagram of a continuous mobile live broadcasting device according to the present invention.

FIG. 2 is an exemplary diagram of providing an image of an input area.

FIG. 3 is an exemplary diagram of providing an image in a plurality of directions.

FIG. 4 is an exemplary diagram of the image of the input area.

FIG. 5 is a control block diagram.

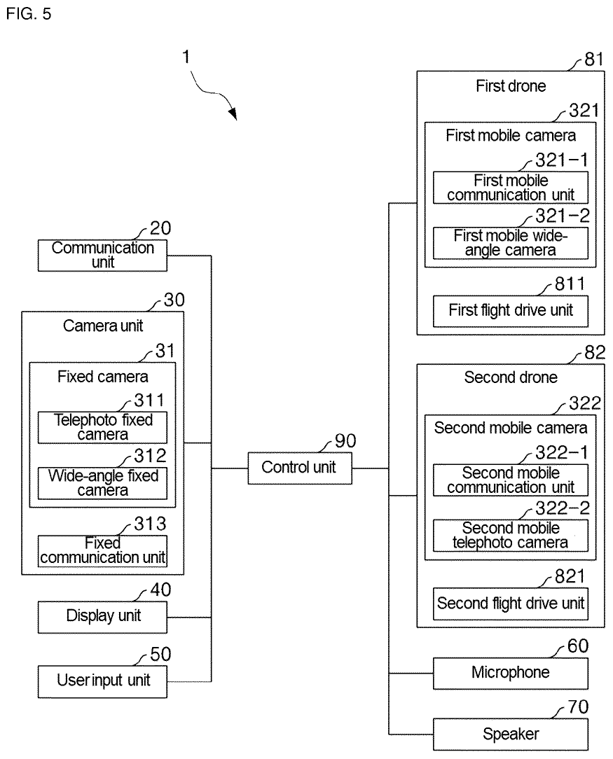

FIG. 6 is an exemplary diagram of an actual configuration of a continuous mobile live broadcasting device.

FIG. 7 is an exemplary diagram of a real-time relay while moving a production line at a site.

FIG. 8 is an exemplary diagram of a real-time relay while moving between a partitioned office, factory, warehouse, and research room.

### MODE FOR INVENTION

Hereinafter, a continuous mobile live broadcasting device 1 according to preferred embodiments of the present invention will be described with reference to the accompanying drawings.

In the case of a real-time relay outdoors, an existing relay device transmits an image and an audio to relay equipment of a base camp by moving only a camera to a site in a state in which the relay equipment is present in the base camp, and even in this case, since wireless signals received from a plurality of cameras are different, it is difficult to synchronize the image and the audio. Therefore, a transmission delay phenomenon occurs because technical work such as synchronization is required after receiving the signals from the plurality of cameras without being relayed in real time. In order to improve the transmission delay, a movable relay vehicle is used, but a place where the relay vehicle may move is very limited.

In order to improve the delay phenomenon, when wireless communication is replaced with wired communication, the relay may be conducted without the delay phenomenon, but the relay is also very limited due to the problem that the relay device may not move in a fixed place.

As a non-face-to-face conference is activated, a real-time video conference is being conducted. However, in order to conduct on-site inspections that require moving around and visiting various places, the fixed relay system has a difficulty due to space limitations.

Further, when he/she tries to view a product, to view a process, or to provide video information about a site desired by buyers while conducting a real-time conference such as product introduction with an overseas company, the effect of continuous mobile real-time video conferencing is expected to significantly increase when video data is rapidly provided and detailed video and audio information is provided.

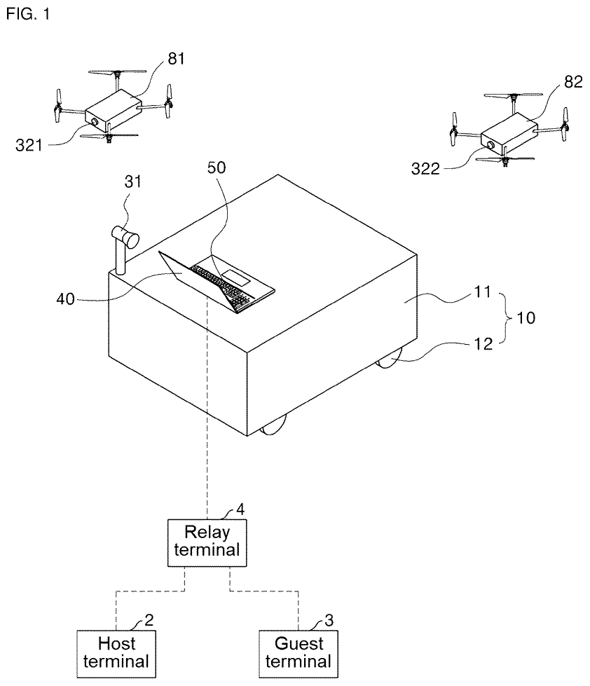

FIG. 1 is an exemplary diagram of a continuous mobile live broadcasting device 1 according to the present invention.

The mobile live broadcasting device 1 is connected to a relay terminal 4 using a wireless communication unit, and a plurality of terminals of a host terminal 2 and a guest terminal 3 are connected to the relay terminal 4. The mobile live broadcasting device 1 may be connected as described above to conduct a relay or a video conference. In this case, the relay terminal 4 may include a server to transmit various data stored in the mobile live broadcasting device 1, the host terminal 2, and the guest terminal 3.

The mobile live broadcasting device 1 may provide various images in a plurality of places while moving, and may provide images captured at various positions. Since the mobile live broadcasting device 1 has both a fixed camera 31 and a mobile camera 32 as configurations, a video conference may be conducted as the mobile live broadcasting device 1 moves, and various images captured in various places may be provided.

A configuration of the mobile live broadcasting device 1 will be described with reference to FIG. 1.

The mobile live broadcasting device 1 includes a mobile cart 10, a communication unit 20, a camera unit 30, a display unit 40, a user input unit 50, a microphone 60, a speaker 70, a drone 80, and a control unit 90.

The mobile cart 10 includes a cart body 11 having shelves formed thereon and wheel units 12 supported by the cart body 11 for moving. The mobile cart 10 supports the communication unit 20, the camera unit 30, the display unit 40, the user input unit 50, the microphone 60, the speaker 70, the drone 80, and the control unit 90, which will be described later.

The communication unit 20 is supported by the mobile cart 10 and transmits and receives data to and from the relay terminal 4.

The camera unit 30 is provided so as to capture a fixed place and large and diverse places. The camera unit 30 includes the fixed camera 31 and the mobile camera 32.

The fixed camera 31 is supported by the mobile cart 10 to capture an image, and at least one or more fixed cameras may be provided. The fixed camera 31 includes a telephoto fixed camera 311, a wide-angle fixed camera 312, and a fixed communication unit 313.

The telephoto fixed camera 311 is provided so as to capture a place far away from the mobile cart 10 by zooming in the place.

The wide-angle fixed camera 312 may capture a place close to the mobile cart 10 with a wide-angle to capture a wide portion.

The fixed communication unit 313 may be provided in each of the telephoto fixed camera 311 and the wide-angle fixed camera 312 to transmit the captured image to the relay terminal 4.

The mobile camera 32 is separated from the mobile cart 10 to capture various places such as a far place. A plurality of mobile cameras 32 may include a first mobile camera 321 and a second mobile camera 322.

The first mobile camera 321 includes a first mobile communication unit 321-1 and a first mobile wide-angle camera 321-2. The first mobile communication unit 321-1 may transmit the image captured by the first mobile wide-angle camera 321-2 to the relay terminal 4. The first mobile wide-angle camera 321-2 may capture the image with a wide-angle to capture a wide portion.

The second mobile camera 322 includes a second mobile communication unit 322-1 and a second mobile telephoto camera 322-2. The second mobile communication unit 322-1 may transmit the image captured by the second mobile telephoto camera 322-2 to the relay terminal 4. The second mobile telephoto camera 322-2 may capture the image with a wide-angle to capture a wide portion.

The display unit 40 may display an image including the image captured by the camera unit 30 and an image received from the relay terminal 4.

The use input unit 50 inputs a user's command.

The microphone 60 may be installed on the mobile cart 10 and the mobile camera 32 to receive a voice generated around the mobile cart 10 and the mobile camera 32.

The speaker 70 may be installed in the mobile cart 10 or the mobile camera 32 to output the voice around the mobile cart 10 or the mobile camera 32.

A plurality of drones 80 are provided, and include a first drone 81 and a second drone 82.

The first drone 81 may fly by driving a first flight drive unit 811. The first flight drive unit 811 may include a motor, a propeller, and the like.

The second drone 82 may fly by driving a second flight drive unit 821. The second flight drive unit 821 may include a motor, a propeller, and the like.

The control unit 90 controls the communication unit 20 to transmit the image captured by the camera unit 30 to the relay terminal 4 such that the image is displayed on the host terminal 2 and the guest terminal 3, controls the display unit 40 to display an image of the host terminal 2 received from the relay terminal 4, an image of the guest terminal 3, and the image captured by the camera unit 30, and control, when area data of any one area from among image areas captured by the camera unit 30 is input from the host terminal 2, the guest terminal 3, and the user input unit 50, at least one mobile camera 32 such that at least one mobile camera 32 moves to an area corresponding to the input area data to capture the image.

The control unit 90 controls the plurality of mobile cameras 32 to move to the area corresponding to the input area data and macro-capture an image of the area corresponding to the area data that is input in at least two directions so as to transmit the macro-captured image to the relay terminal 4.

The control unit 90 controls the plurality of mobile cameras 32 such that when a repetitive movement operation is recognized in the macro-captured image, a pattern of the repetitive movement operation may be simultaneously captured.

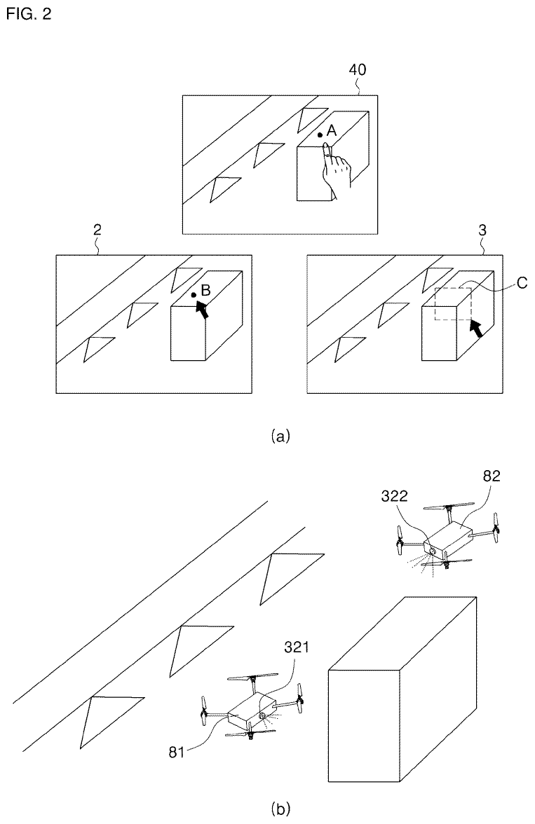

FIG. 2 is an exemplary diagram of providing an image of an input area.

FIG. 2(a) shows selection of point A and point B or drag of area C using the relay terminal 4 during a video conference of the mobile live broadcasting device 1, the host terminal 2, and the guest terminal 3.

In FIG. 2(b), when a user, a host, and a guest touch the captured image by hand or click and drag the captured image with a mouse, the first drone 81 and the second drone 82, in which the mobile cameras 321 and 322 are accommodated, respectively, move to point A, point B, and area C to capture point A, point B, and area C in a plurality of directions, thereby providing captured images thereof.

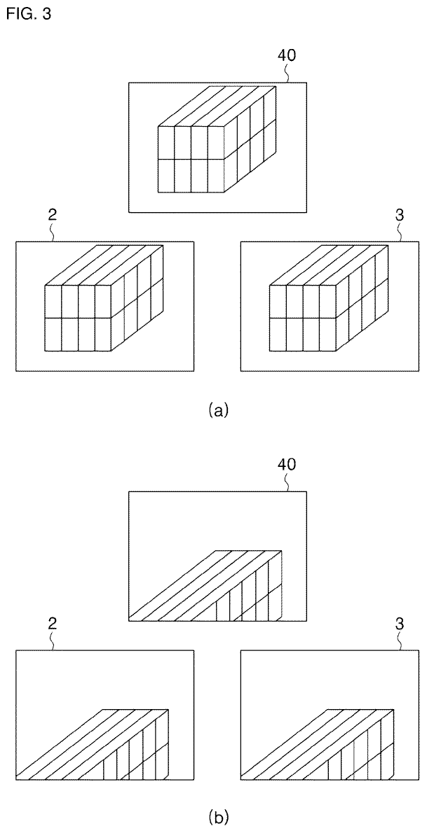

FIG. 3 is an exemplary diagram of providing an image in a plurality of directions.

In FIG. 3(a), an image captured in one direction, which is one of the images obtained by capturing the point, point B, and area C in the plurality of directions in FIG. 2, is displayed on the mobile live broadcasting device 1, the host terminal 2, and the guest terminal 3.

In FIG. 3(b), an image captured in a direction different from the one direction, which is one of the images obtained by capturing the point, point B, and area C in the plurality of directions in FIG. 2, is displayed on the mobile live broadcasting device 1, the host terminal 2, and the guest terminal 3.

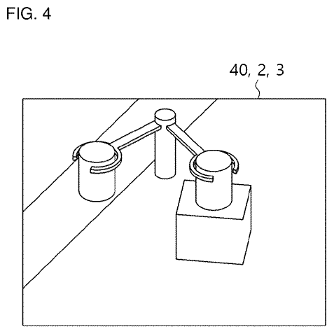

FIG. 4 is an exemplary diagram of the image of the input area.

When the user, the host, and the guest touch the captured image by hand or click and drag the captured image with a mouse, the mobile cameras 321 and 322 move to the input place and captures an image thereof, and the control unit 90 may recognize the repetitive movement operation in the received captured image, and may control the mobile cameras 321 and 322 to move the first drone 81 and the second drone 82, in which the mobile cameras 321 and 322 are accommodated, such that the pattern of the repetitive movement operation may be simultaneously captured, or the control unit 90 may use a zoom function of the mobile cameras 321 and 322 to contain the pattern of the repetitive movement operation on one screen.

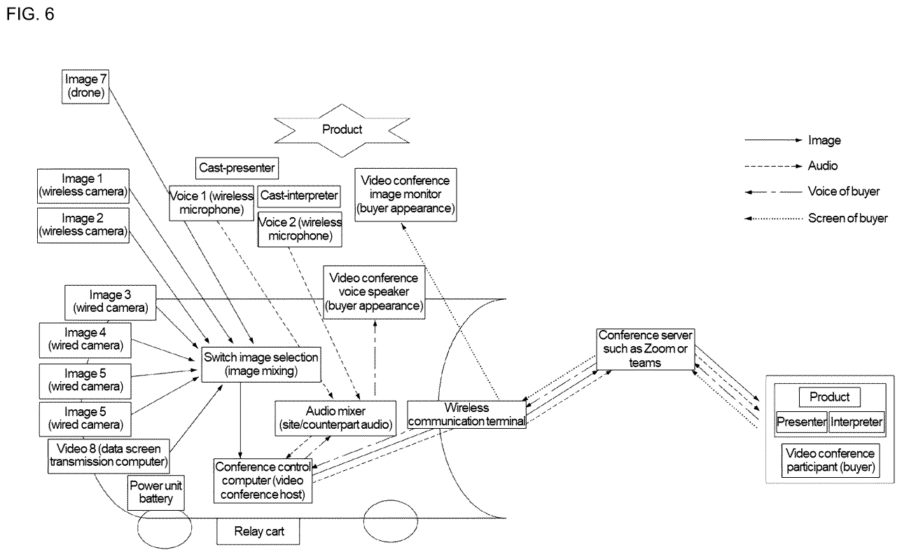

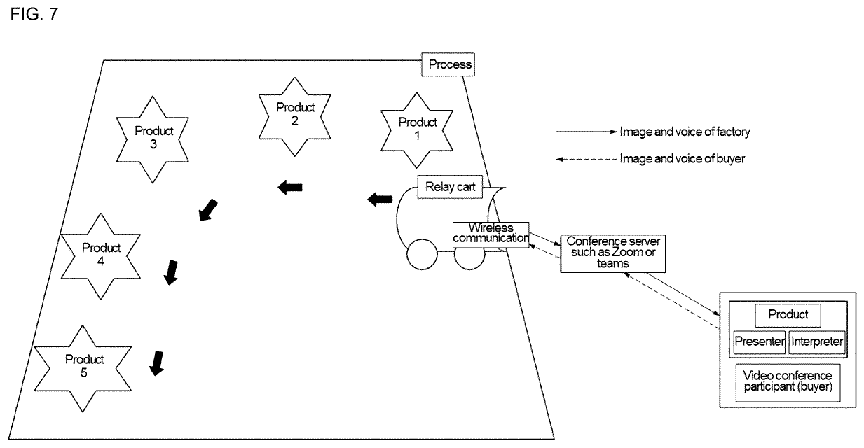

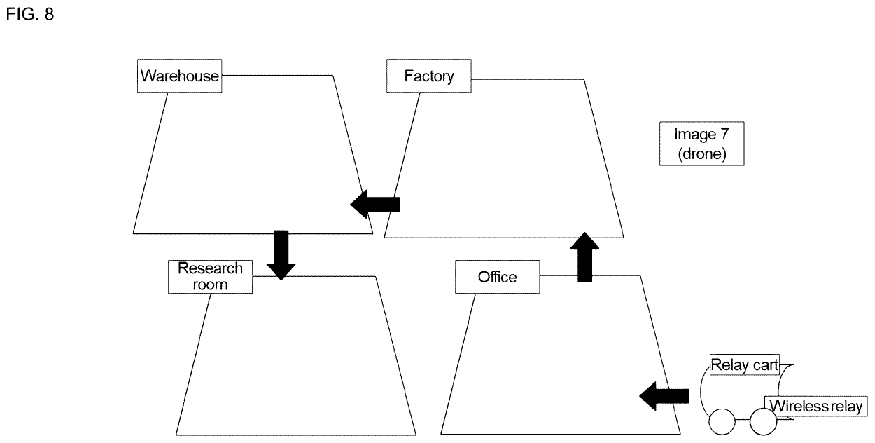

FIG. 6 is an exemplary diagram of an actual configuration of the continuous mobile live broadcasting device 1, FIG. 7 is an exemplary diagram of a real-time relay while moving a production line at a site. and FIG. 8 is an exemplary diagram of a real-time relay while moving between a partitioned office, factory, warehouse, and research room.

A modifiable embodiment other than the embodiments described above will be described.

The control unit 90 may store data about processes and products in each site, and when the user, the host, and the guest touch the captured image by hand, click the captured image with a mouse, and drag the captured image with a mouse, the control unit 90 may control the mobile cameras 321 and 322 to move to the input place and to transmit the data about processes and products for the input place to the mobile live broadcasting device 1, the host terminal 2, and the guest terminal 3.

The control unit 90 stores a transmission form for transmitting input materials such as products and materials for processes of the input place along with the captured image, so that when the user, the host, and the guest touch the captured image by hand, click the captured image with a mouse, and drag the captured image with a mouse, the control unit 90 loads the materials such as products and materials for processes of the input place into the transmission form, and when the captured image is received from the mobile cameras 321 and 322, the control unit 90 loads only an image frame having predetermined clarity or higher to the transmission form and transmits the image frame.

The mobile live broadcasting device may further include an image connector for selecting any one of the images received from the plurality of cameras and transmitting the selected image to the relay terminal. The image connector may have a button that may be directly selected by the user. The control unit may control a corresponding microphone among a plurality of microphones to be selected in response to the selected camera among a plurality of voices.

The mobile live broadcasting device may further include a battery unit for supplying power to all configurations supported by the mobile cart.

A signal processing unit is provided so as to process the image and audio received from the plurality of cameras and the plurality of microphones and relay the image and audio in real time.

The control unit may divide an area of the display unit to display the image of the site and the image of the host and the guest in a separate area.

The mobile live broadcasting device may further include a video player unit capable of transmitting an existing material image in addition to the camera.

The mobile live broadcasting device may further include an audio mixing unit that fuses an audio of a cast and an audio of a viewer in real time to enable a video conference without sound delay.

The mobile live broadcasting device 1 provides an image by conducting a real-time relay to the host terminal 2 and the guest terminal 3 by using the relay terminal while moving using the mobile cart 10, and when the area data is input from a relay image among real-time images, the mobile cameras 321 and 322 capture the image while moving to the input area data, so that it is possible to rapidly provide a clear image, thereby improving a speed of data provision and clarity of the provided data.

### DESCRIPTION OF REFERENCE NUMERALS

1: mobile live broadcasting device 2: host terminal
3: guest terminal 4: relay terminal
10: mobile cart 11: cart body
12: wheel unit communication unit
30: camera unit 31: fixed camera
311: telephoto fixed camera 312: wide-angle fixed camera
313: fixed communication unit 32: mobile camera
321: first mobile camera 322: second mobile camera
40: display unit 50: user input unit
60: microphone speaker
80: drone 81: first drone
82: second drone 90: control unit

1. A continuous mobile live broadcasting device which conducts a real-time relay with a plurality of terminals including a host terminal and a guest terminal by using a relay terminal that enables the real-time relay, the continuous mobile live broadcasting device comprising:
a mobile cart including a cart body having shelves formed thereon and wheel units supported by the cart body for moving;
a communication unit supported by the mobile cart and configured to transmit and receive data to and from the relay terminal;
a camera unit including at least one fixed camera supported by the mobile cart to capture an image and at least one mobile camera separated from the mobile cart, having a mobile communication unit, and configured to capture an image;
a display unit configured to display an image including an image captured by the camera unit;
a user input unit configured to input a user's command; and
a control unit configured to control the communication unit to transmit the image captured by the camera unit to the relay terminal such that the image is displayed on the host terminal and the guest terminal, to control the display unit to display an image of the host terminal received from the relay terminal, an image of the guest terminal, and the image captured by the camera unit, and to control, when area data of any one area from among image areas captured by the camera unit is input from the host terminal, the guest terminal, and the user input unit, the at least one mobile camera such that the at least one mobile camera moves to an area corresponding to the input area data to capture the image.

2. The continuous mobile live broadcasting device of claim 1, wherein the at least one mobile camera includes a plurality of mobile cameras, and
the control unit controls the plurality of mobile cameras to move to the area corresponding to the input area data and macro-capture an image of an area corresponding to the area data that is input in at least two directions so as to transmit the macro-captured image to the relay terminal.

3. The continuous mobile live broadcasting device of claim 2, wherein the control unit controls the plurality of mobile cameras to move such that, when a repetitive movement operation is recognized in the macro-captured image, a pattern of the repetitive movement operation is simultaneously captured.

4. The continuous mobile live broadcasting device of claim 2, wherein the plurality of mobile cameras include a telephoto camera with a telephoto lens capturing a long distance area and a wide-angle camera with a wide-angle lens capturing a wide area.

5. The continuous mobile live broadcasting device of claim 1, wherein each of the plurality of mobile cameras further includes at least one microphone configured to receive a voice including a user's voice.
